(19) United States
(12) Patent Application Publication
(10) Pub. No.: US 2006/0247409 A1
(43) Pub. Date: Nov. 2, 2006

(54) Novel organosilicon compounds and a method for their production

(75) Inventors: Oliver Schaefer, Burghausen (DE); Andreas Bauer, Simbach (DE); Markus Kriegbaum, Neumarkt (DE); Sandra Rachl, Handenberg (AT)

Correspondence Address: BROOKS KUSHMAN P.C., 1000 TOWN CENTER, TWENTY-SECOND FLOOR, SOUTHFIELD, MI, 48075, US

(73) Assignee: CONSORTIUM FUER ELEKTROCHEMISCHE INDUSTRIE GMBH, Munich (DE)

(21) Appl. No.: 10/595,036

(22) PCT Filed: Jul. 1, 2004
(86) PCT No.: PCT/EP04/07174

§ 371 Date: Jun. 12, 2006

(30) Foreign Application Priority Data
Jul. 10, 2003 (DE) 103312897

(51) Int. Cl. C08G 77/26

(52) U.S. Cl. 528/38

(57) ABSTRACT

Phosphorous-modified organosilicon compounds containing silicon-bound methoxy groups and a methylene spacer linking silicon to the phosphorous moiety are easily prepared in high yield and exhibit excellent hydrolysis rates. The compounds are useful, inter alia, as stabilizers in anti-freeze compositions, as cohydrolysis reactants in preparation of modified silicone resins, and in coatings.

The invention relates to novel phosphorus-modified organosilicon compounds containing at least one methoxy group bound to the silicon and a process for preparing them by addition of silanes having a halogen-carbon bond onto esters of phosphorous acid.

Phosphorus-modified alkylsilanes are of great economic interest in many fields. They can be used, for example, as bonding agents, as crosslinkers, for the functionalization of silicones, silicone resins such as silesquioxanes or metal oxides such as pyrogenic silicas or for modifying the properties of glycols.

The Japanese patent specification JP 63023976 describes a treatment agent for solid materials which comprises an organopolysiloxane having a phosphonic ester group and improves the antistatic properties and hydrophobicity. Furthermore, the international published specification WO 2002/055587 A1 likewise describes organopolysiloxanes containing phosphonic ester groups and also a process for preparing them for the functionalization of silicone resins such as silesquioxanes and their use as acid catalysts. In the patent specifications U.S. Pat. No. 4,333,843, U.S. Pat. No. 4,367,154 and U.S. Pat. No. 4,676,919, the properties, for example gelation resistance and storage stability or corrosivity, of glycols is positively influenced by the addition of trialkoxysilane propyl phosphonates.

Phosphorus-modified silanes have the sought-after ability of simultaneously improving the hydrophilicity, polarity, antistatic properties, catalytic properties and the nonflammability of materials modified therewith.

Phosphorus-modified silanes are generally prepared by reaction of trialkyl phosphites with chloropropyl-modified siloxanes or silanes, as described, for example, in Gallagher et al., J. Polym. Sci. Part A, Vol. 41, 48-59 (2003). A disadvantage of this reaction is that long reaction times and high temperatures are required, which leads to rearrangements in the product and thus to losses in yield.

The reaction of trialkyl phosphites with chloromethyl-modified siloxanes as described in U.S. Pat. No. 2,768,193 or by Gallagher et al. proceeds significantly more quickly, but has the disadvantage that the siloxanes prepared in this way can be purified by distillation only with difficulty because of their high boiling point and, furthermore, are suitable only to a limited extent for the functionalization of, for example, silicone resins or as bonding agents, since the Si—O—Si bond on which they are based is virtually unreactive.

An alternative is the use of halomethyl-modified ethoxysilanes, which in the reaction with trialkyl phosphites lead to distillable phosphonatoethoxysilanes. However, these ethoxysilanes have the disadvantage that the chloromethylethoxysilanes used in the synthesis are not produced on an industrial scale and their hydrolysis rate is relatively low. This leads to, for example, a cohydrolysis with methoxysilanes to prepare functionalized silicone resins not being able to be carried out, since the more reactive methoxysilanes react completely first and the less reactive functional ethoxysilanes react afterward.

A further possible way of preparing the desired compounds is the reaction of chloroalkylsilanes with phosphonates described in the patent specification U.S. Pat. No. 3,019,248. However, this reaction is carried out using metals, for example sodium, to increase the reaction rate, which is not readily able to be realized in industrial reaction plants.

It was then an object of the present invention to make it possible to obtain phosphorus-modified silanes which can be prepared in a very simple fashion from commercially available chemicals in short reaction times and in good yields and at the same time have a high reactivity.

This object is achieved by phosphorus-modified silanes which contain at least one methoxy group bound to the silicon and have the general formula I: 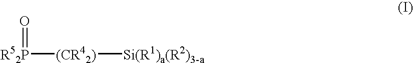
where
the radicals R¹ are each, independently of one another, a substituted or unsubstituted alkyl, alkenyl, cycloalkyl or aryl group having from 1 to 18 carbon atoms or an alkoxy group having from 2 to 18 carbon atoms,
R² is a methoxy group,
the radicals R⁴ are each, independently of one another, hydrogen, an alkyl, cycloalkyl or aryl group which has from 1 to 18 carbon atoms and may be substituted by fluorine, chlorine, alkoxy, amine, cyanate or isocyanate groups or be unsubstituted,
the radicals R⁵ are each, independently of one another, a substituted or unsubstituted alkoxy group or aryloxy group having from 1 to 18 carbon atoms, a substituted or unsubstituted polyalkylene oxide having from 1 to 4000 carbon atoms and
a is an integer from 0 to 2,
   with the proviso that R¹, R⁴ or R⁵ can together be part of a cyclic compound.

R¹ is preferably an alkyl radical and very particularly preferably a methyl radical. R⁴ is preferably hydrogen and R⁵ is preferably an alkoxy group having 1-4 carbon atoms and very particularly preferably an ethoxy group.

It has also been found that the desired target products can be obtained in yields of greater than 75% when the products of the general formula I are prepared by reacting compounds of the general formula II:
X—(CR⁴₂)—Si—(R¹)ₐ(R²)₃₋ₐ (II)
where R¹, R², R⁴ are as defined above and X is fluorine, chlorine, bromine or iodine, with compounds of the general formula III:
P(R⁵)₃ (III)
where R₅ is as defined above.

X is a halogen, i.e. fluorine, chlorine, bromine or iodine, preferably chlorine or bromine, particularly preferably chlorine.

Here, an excess of preferably from 0.01 to 300 mol %, particularly preferably from 10 to 100 mol %, of the reaction component of the general formula III is reacted with a silane of the general formula II at elevated temperature, preferably from 80 to 170° C., particularly preferably from 100 to 155° C. This reaction can, if appropriate, be carried out in an inert solvent, but is preferably carried out without solvent.

For example, the reaction components of the general formula III are placed in a reaction vessel and the reaction component of the general formula II is added while stirring. In another variant, the reaction components of the general formula II are placed in a reaction vessel and the reaction component of the general formula III is added while stirring. The reaction time to be employed is generally from 10 to 1000 minutes. The reaction is carried out at a temperature of from 0 to 300° C., preferably from 25 to 200° C., particularly preferably from 80 to 170° C. The use of superatmospheric pressure, preferably up to 10 bar, may also be useful.

The crude products of the general formula I prepared in this way by the process of the invention are generally worked up by distillation, but if the reaction is carried out in an appropriate manner the work-up may also be able to be omitted.

The present invention further provides for the use of the inventive phosphorus-modified silanes of the general formula I as additives in antifreezes or as coating agent.

Furthermore, the cohydrolysis of the inventive phosphorus-modified silanes of the general formula I in combination with alkoxyalkylsilanes for preparing functionalized resins is also subject matter of the present invention.

The invention is illustrated by the following examples.

### EXAMPLE 1

99.7 g (0.6 mol) of triethyl phosphite (P(OEt)₃, Aldrich, GC 98%) were placed under a nitrogen atmosphere in a 250 ml three-necked flask provided with a dropping funnel and reflux condenser. After heating to 140° C., 46.4 g of chloromethyldimethoxymethylsilane (0.3 mol) (Wacker-Chemie GmbH) were slowly added dropwise over a period of 3 hours while stirring vigorously. The reaction mixture was subsequently heated at 170° C. for another 30 minutes. After taking off the excess triethyl phosphite under reduced pressure, 58.6 g of diethoxyphosphitomethyldimethoxymethylsilane (0.23 mol, GC 98%, yield: 76% of theory) were distilled off at a temperature of 133° C. under a pressure of 12 mbar.

### EXAMPLE 2

46.4 g (0.3 mol) of chloromethyldimethoxymethylsilane (Wacker-Chemie GmbH) were placed under a nitrogen atomosphere in a 250 ml three-necked flask provided with a dropping funnel and reflux condenser. After heating to 130° C., 75 g (0.45 mol) of triethyl phosphite (P(OEt)₃, Aldrich, GC 98%) were added dropwise with gas evolution (ethyl chloride) over a period of 3 hours while stirring vigorously. The reaction mixture was subsequently heated at 170° C. for another 30 minutes. After taking off the excess triethyl phosphite under reduced pressure, 65.1 g of diethoxyphosphitomethyldimethoxymethylsilane (255 mmol, GC 99%, yield: 85% of theory) were distilled off at a temperature of 133° C. under a pressure of 13 mbar.

### EXAMPLE 3

124.5 g (0.75 mol) of triethyl phosphite (P(OEt)₃, Aldrich, GC 98%) were placed under a nitrogen atmosphere in a 250 ml three-necked flask provided with a dropping funnel and reflux condenser. After heating to 140° C., 69.3 g of chloromethyldimethylmethoxysilane (0.5 mol) (Wacker-Chemie GmbH) were slowly added dropwise over a period of 2.5 hours while stirring vigorously. The reaction mixture was subsequently heated at 170° C. for another 30 minutes. After taking off the excess triethyl phosphite under reduced pressure, 100.4 g of diethoxyphosphitomethyldimethylmethoxysilane (0.42 mol, GC 98.2%, yield: 83.6% of theory) were distilled off at a temperature of 118-122° C. under a pressure of 11 mbar.

### EXAMPLE 4

12.2 g (0.675 mol) of triethyl phosphite (P(OEt)₃, Aldrich, GC 98%) were placed under a nitrogen atmosphere in a 250 ml three-necked flask provided with a dropping funnel and reflux condenser. After heating to 140° C., 76.8 g of chloromethyltrimethoxysilane (0.45 mol) (Wacker-Chemie GmbH) were slowly added dropwise over a period of 2.5 hours while stirring vigorously. The reaction mixture was subsequently heated at 170° C. for another 30 minutes. After taking off the excess triethyl phosphite under reduced pressure, 105.6 g of diethoxyphosphitomethyltrimethoxysilane (0.39 mol, GC 97.4%, yield: 86.2% of theory) were distilled off at a temperature of 135-138° C. under a pressure of 12 mbar.

### EXAMPLE 5

### Not According to the Invention

99.7 g (0.6 mol) of triethyl phosphite (P(OEt)₃, Aldrich, GC 98%) were placed under a nitrogen atmosphere in a 250 ml three-necked flask provided with a dropping funnel and reflux condenser. After heating to 140° C., 85.1 g of chloromethyltriethoxysilane (0.4 mol) (Wacker-Chemie GmbH) were slowly added dropwise over a period of 1.5 hours while stirring vigorously, The reaction mixture was subsequently heated at 170° for another 1.5 hours to remove the ethyl chloride formed. After taking off the excess triethyl phosphite under reduced pressure, 95.8 g of diethoxyphosphitomethyltrimethoxysilane (0.31 mol, GC 98%, yield: 77.4% of theory) were distilled off at a temperature of 146° C. under a pressure of 11-13 mbar.

### EXAMPLE 6

### Hydrolysis

The hydrolysis was carried out in aqueous solution at a pH of 4 which was set by means of sodium acetate/acetic acid buffer. The determination of the conversion was carried out by means of NMR. The result is shown in Table 1.

TABLE 1

| Time | Ethoxy groups on the | Methoxy groups on the |
|---|---|---|
| [min] | triethoxysilane [mol %] | trimethoxysilane [mol %] |
| 0 | 100.00% | 100.00% |
| 2 | 88.60% | 33.30% |
| 7 | 85.30% | 12.30% |
| 12 | 74.60% | 4.80% |
| 17 | 64.70% | 2.00% |
| 22 | 55.90% | 1.20% |
| 27 | 48.50% | 0.90% |
| 32 | 41.50% | 0.60% |
| 37 | 36.30% | 0.50% |
| 42 | 31.00% | n.d. |
| 47 | 27.00% | 0.50% |
| 52 | 23.10% | n.d. |
| 57 | 20.00% | n.d. |
| 62 | 17.40% | n.d. |
| 110 | 6.50% | n.d. |

The content of alkoxy groups bound to silicon was determined. It can clearly be seen that the methoxy derivatives according to the invention have a reaction rate which is from 15 to 20 times as high as that of the ethoxy derivatives which are not according to the invention.

### EXAMPLE 7

In a 250 ml flask, 13.5 g (50 mmol) of diethoxy-phosphitomethyltrimethoxysilane and 6 g of dimethyldimethoxysilane were dissolved in 150 ml of a water/acetone solution (50/50). The mixture was subsequently allowed to stand at room temperature for 3 days and the solvent mixture was subsequently removed on a rotary evaporator. This gave 14.1 g of a homogeneous white powder which was able to be identified by means of GPC and NMR as homogeneous silicone resin without proportions of linear siloxane.

### EXAMPLE 8

As a model for a commercial antifreeze, ethylene glycol was admixed with various corrosion inhibitors and additives. 917 g of ethylene glycol (Riedel-de Haen) were admixed with 13 g of sodium metaborate hydrate (Aldrich) (as 25% strength solution in ethylene glycol), 6 g of an aqueous sodium nitrate solution (33% by weight, Merck), a solution of 3 g of sodium metasilicate Na₂SiO₃ (Aldrich) in 10 g of water, 1.5 ml of a 10% strength NaOH solution and various contents of diethoxymethylphosphitotrimethoxysilane (referred to as silane). The mixture was subsequently heated to 80° C. and the temperature was maintained over a period of time. The time which elapsed until gel particles occurred was measured. The corresponding gelation time is shown in Table 2.

TABLE 2

| | Gelation time |
|---|---|
| 0 ppm of silane | 15 h |
| 30 ppm of silane | 70 h |
| 100 ppm of silane | 120 h |
| 200 ppm | 200 h |

The example clearly shows that even small amounts of silane according to the invention increase the stability of the antifreeze.

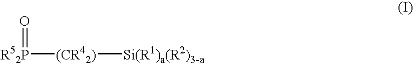

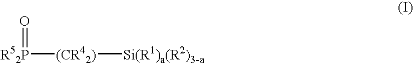

1-10. (canceled)

11. A phosphorus-modified silane which contains at least one methoxy group bound to the silicon and has the general formula (I): 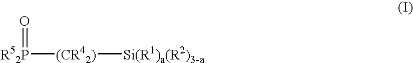
where
the radicals R¹ are each, independently of one another, a substituted or unsubstituted alkyl, alkenyl, cycloalkyl or aryl group having up to 18 carbon atoms or an alkoxy group having from 2 to 18 carbon atoms,
R² is a methoxy group,
the radicals R⁴ are each, independently of one another, hydrogen, an alkyl, cycloalkyl or aryl group which has up to 18 carbon atoms, optionally substituted by fluorine, chlorine, alkoxy, amine, cyanate or isocyanate group(s),
the radicals R⁵ are each, independently of one another, a substituted or unsubstituted alkoxy group or aryloxy group having up to 18 carbon atoms, or a substituted or unsubstituted polyalkylene oxide having up to 4000 carbon atoms and
a is an integer from 0 to 2,
with the proviso that two or more of R¹, R⁴ and R⁵ can together be part of a cyclic structure.

12. A process for preparing phosphorus-modified silanes of claim 11 which contain at least one methoxy group bound to silicon and have the formula (I): 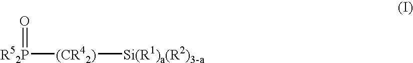
where
the radicals R¹ are each, independently of one another, a substituted or unsubstituted alkyl, alkenyl, cycloalkyl or aryl group having up to 18 carbon atoms or an alkoxy group having from 2 to 18 carbon atoms,
R² is a methoxy group,
the radicals R⁴ are each, independently of one another, hydrogen, an alkyl, cycloalkyl or aryl group which has up to 18 carbon atoms, optionally substituted by fluorine, chlorine, alkoxy, amine, cyanate or isocyanate group(s),
the radicals R⁵ are each, independently of one another, a substituted or unsubstituted alkoxy group or aryloxy group having up to 18 carbon atoms, or a substituted or unsubstituted polyalkylene oxide having from 1 to 4000 carbon atoms and
a is an integer from 0 to 2,
with the proviso that two or more of R¹, R⁴ and R⁵ can together be part of a cyclic structure,
wherein at least one compound of the formula (II):
X—(CR⁴₂)—Si—(R¹)ₐ(R²)₃₋ₐ (II)
where
X is fluorine, chlorine, bromine or iodine,
is reacted with at least one compound of the formula (III):
P(R⁵)₃ (III).

13. The process of claim 12, wherein the reaction is carried out at a temperature of from 0° C. to 300° C.

14. The process of claim 12, wherein the reaction is carried out at a temperature of from 80° C. to 170° C.

15. The process of claim 12, wherein the reaction component of the general formula III is reacted in an excess of from 0.01 to 300 mol % with a silane of the formula (II).

16. The process of claim 12, wherein the reaction component of the formula (III) is reacted in an excess of from 10 to 100 mol % with a silane of the formula (II).

17. The process of claim 12, wherein the reaction is carried out in the absence of a solvent.

18. The process of claim 12, wherein the reaction is carried out at a pressure of from 1 to 10 bar.

19. In an antifreeze or coating, the improvement comprising selecting as one component of said antifreeze or coating, the phosphorus-modified silane of formula (I) of claim 11.

20. A functionalized organopolysiloxane resin, comprising a cohydrolysis product of a phosphorous-modified silanes of the formula I of claim 11 in combination with at least one alkoxyalkylsilane.

21. The phosphorous-modified silane of claim 11, in combination with one or more alkylene glycols comprising a stabilized antifreeze.
